(19) United States
(12) Patent Application Publication
(10) Pub. No.: US 2014/0355405 A1
(43) Pub. Date: Dec. 4, 2014

(54) DISC DRIVE TESTING SIGNAL GENERATION DEVICE AND RELATED METHOD

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: XIAO-WEI YANG, Shenzhen (CN); JUN-JUAN GAO, Shenzhen (CN); YANG WANG, Shenzhen (CN); CHUN-CHING CHEN, New Taipei (TW)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/261,582

(22) Filed: Apr. 25, 2014

(30) Foreign Application Priority Data
May 29, 2013 (CN) 2013102062972

(51) Int. Cl. G11B 20/18

(52) U.S. Cl. CPC G11B 20/1816
USPC 369/53.37

(57) ABSTRACT

A testing signal generation device for testing performance of a disc drive includes a signal generating unit, a signal converting unit, and a signal transmitting unit. The signal generating unit generates at least one pulse signal for controlling the disc drive to work at predetermined working modes. The signal converting unit converts the at least one pulse signal into at least one test signal. The signal transmitting unit transmits the at least one test signal to the disc drive, to control the disc drive to read data from an optical disc in the disc drive. A testing signal generation method for testing performance of the disc drive is also provided.

### FIELD

The present disclosure relates to test technologies of electronic devices, and particularly to a testing signal generation device and method for testing performance of disc drives.

### BACKGROUND

In a typical method for testing the performance of a disc drive, a remote controller of the disc drive is manually operated to control the disc drive to work in different modes to make a display connected to the disc drive to display different information. For example, an operator can press a stop button, a playback button, a fast-forward button, or a rewind button of the remote controller to control the disc drive to execute corresponding functions. Then, the operator can manually determine whether the disc drive works normally according to the information displayed on the display.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of an embodiment of a testing signal generation device, a disc drive, and a display device.

FIG. 2 is a schematic block diagram of an embodiment of the testing signal generation device of FIG. 1.

FIG. 3 is a flowchart of an embodiment of a testing signal generation method implemented by the test signal generation device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

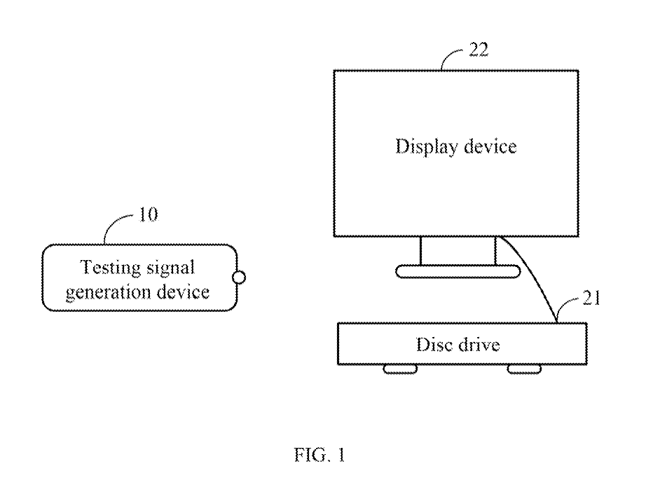

FIG. 1 shows a schematic diagram of a testing signal generation device 10, a disc drive 21, and a display device 22. In the embodiment, the disc drive 21 is electrically connected to the display device 22. The testing signal generation device 10 is configured to test performance of the disc drive 21. In the embodiment, a predetermined optical disc (not shown) storing video files is provided in the disc drive 21 in order to test the performance of the disc drive 21. The display device 22 is configured to display data read from the optical disc. When the disc drive 21 receives a test signal transmitted from the testing signal generation device 10, the display device 22 displays the data, and whether or not the disc drive 21 works normally can be determined according to the data display on the display device 22. In alternative embodiments, the display device 22 can be replaced by a display screen (e.g., a liquid crystal display) of the disc drive 21.

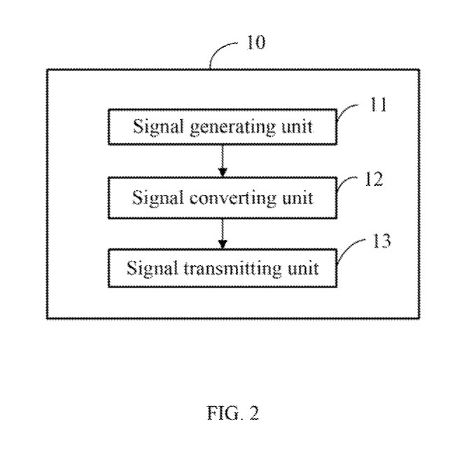

FIG. 2 shows a block diagram of an embodiment of the testing signal generation device 10. The testing signal generation device 10 includes a signal generating unit 11, a signal converting unit 12, and a signal transmitting unit 13.

The signal generating unit 11 generates an activate signal to activate the display device 22 to display the data read from the optical disc, and generates a plurality of pulse signals to control the disc drive 21 to work in predetermined working modes, such as a stop mode, a playback mode, a fast-forward mode, and a rewind mode. The signal generating unit 11 can generate the plurality of pulse signals at regular intervals or irregular intervals. For example, when the testing signal generation device 10 is turned on, the signal generating unit 11 first generates the activate signal, then generates a first pulse signal after a first predetermined time duration, and then generates a second pulse signal after a second predetermined time duration. The activate signal and the plurality of pulse signals are pulse width modulation (PWM) signals generated at intervals. In at least one embodiment, a duty cycle of the PWM signals is 50%.

The signal converting unit 12 coverts the activate signal into a controlling signal and converts the plurality of pulse signals into a plurality of test signals. In at least one embodiment, the controlling signal and the test signals are infrared light signals.

The signal transmitting unit 13 transmits the controlling signal to the display device 22 to control the display device 22 to receive the data from the disc drive 21, and then transmits the test signals to the disc drive 21 at intervals to control the disc drive 21 to read the data from the optical disc within the disc drive 21.

As described above, the testing signal generation device 10 can automatically generate the test signals to test the disc drive 21, which is convenient, and facilitates the user to test the performance of the disc drive 21.

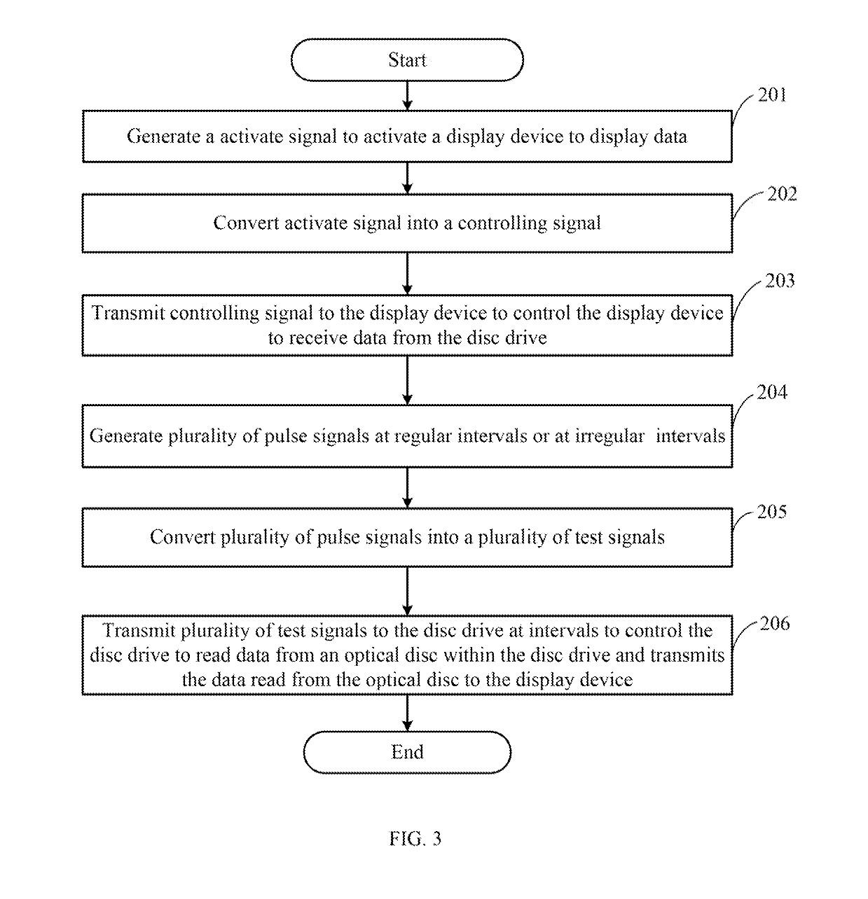

FIG. 3 is a flowchart of an example test signal generation method for testing performance of the disc drive. The testing signal generation method can include the following steps:

In step 201, the signal generating unit generates an activate signal to activate the display device to display data.

In step 202, the signal converting unit converts the activate signal into a controlling signal. In the embodiment, the controlling signal is an infrared light signal.

In step 203, the signal transmitting unit transmits the controlling signal to the display device to control the display device to receive data from the disc drive.

In step 204, the signal generating unit generates a plurality of pulse signals at regular intervals or at irregular intervals.

In step 205, the signal converting unit converts the plurality of pulse signals into a plurality of test signals. In the embodiment, the test signals are infrared light signals.

In step 206, the signal transmitting unit transmits the plurality of test signals to the disc drive at intervals to control the disc drive to read data from an optical disc within the disc drive, and transmits the data read from the optical disc to the display device. Then, the read data is displayed via the display device.

Although the present disclosure has been specifically described on the basis of the exemplary embodiment thereof, the disclosure is not to be construed as being limited thereto. Various changes or modifications may be made to the embodiment without departing from the scope the disclosure. Embodiments described herein are examples, and are not intended to limit the following claims.

What is claimed is:

1. A testing signal generation device for testing performance of a disc drive, the testing signal generation device comprising:
a signal generating unit configured to generate at least one pulse signal for controlling the disc drive to work in predetermined working modes;
a signal converting unit configured to convert the at least one pulse signal into at least one test signal; and
a signal transmitting unit configured to transmit the at least one test signal to the disc drive, to control the disc drive to read data from an optical disc within the disc drive to test whether or not the performance of the disc drive is normal.

2. The testing device as described in claim 1, wherein the at least one test signal is an infrared light signal.

3. The testing device as described in claim 1, wherein the signal generating unit is further configured to generate a plurality of pulse signals at regular intervals or irregular intervals.

4. The testing device as described in claim 1, wherein the at least one pulse signal comprises a plurality of pulse width modulation (PWM) signals generated at intervals.

5. The testing device as described in claim 4, wherein a duty cycle of the PWM signals is 50%.

6. The testing device as described in claim 1, wherein the disc drive is electrically connected to a display device, and the signal generating unit is further configured to generate an activate signal before the at least one pulse signal is generated, the activate signal activating the display device to display the data read from the optical disc.

7. A testing signal generation method for testing performance of a disc drive electrically connected to a display device, the testing signal generation method comprising:
generating at least one pulse signal for controlling the disc drive to work in predetermined working modes;
converting the at least one pulse signal into at least one test signal; and
transmitting the at least one test signal to the disc drive, to control the disc drive to read data from an optical disc within the disc drive to test whether or not the performance of the disc drive is normal.

8. The testing signal generation method as described in claim 7, wherein the at least one test signal is an infrared light signal.

9. The testing signal generation method as described in claim 7, wherein the testing signal generation method further comprising:
generating an activate signal for activating the display device to display the data read from the optical disc ;
converting the activate signal into a controlling signal; and
transmitting the controlling signal to the display device to control the display device to receive the data from the disc drive.

10. The testing signal generation method as described in claim 9, wherein the controlling signal is an infrared light signal.

11. The testing signal generation method as described in claim 7, further comprising:
generating a plurality of pulse signals at regular intervals or irregular intervals.

12. The testing signal generation method as described in claim 7, wherein the at least one pulse signal comprise a plurality of pulse width modulation (PWM) signals generated at intervals.

13. The testing signal generation method as described in claim 12, wherein a duty cycle of the PWM signals is 50%.
